(19) United States
(12) Patent Application Publication
(10) Pub. No.: US 2005/0204102 A1
(43) Pub. Date: Sep. 15, 2005

(54) Register access protocol for multi processor systems

(76) Inventor: Richard David Taylor, Eagle, ID (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/799,047

(22) Filed: Mar. 11, 2004

(51) Int. Cl. G06F 12/00

(52) U.S. Cl. 711/150

(57) ABSTRACT

The present invention provides shared registers in a multi-processor system with a contention management protocol when a register is simultaneously accessed by more than one processor. Each register includes access protocol and data. The access protocol includes an access type for each processors and arbitration priority. The configurable access type being selected from a group that includes READ, READ/CLEAR, READ/SET, and READ/WRITE

### BACKGROUND

Multi-processor systems, e.g. MODEMS, networking peripherals, are becoming commonplace as processor or digital signal processing (DSP) based I/Os are added to systems. The processors may be included within a single chip or located in separate interconnected integrated circuits (ICs). The multi-processor system can communicate via registers, as shown in FIGS. 1 and 2. Care must be taken to prevent the processors from inadvertently corrupting the registers, e.g. concurrent attempts to read-modify-write within the same register. Unless an explicit contention management technique is employed, the registers may become corrupted.

Prior art contention management schemes rely on software, semaphores, or fixed priority hardware arbitration within the registers. The schemes are often error prone, inflexible, and difficult to verify.

### SUMMARY

The present invention provides shared registers in a multi-processor system with a contention management protocol when a register is simultaneously accessed by more than one processor.

Each register includes access protocol and data. The access protocol includes an access type for each processors and arbitration priority. The access type being selected from a group that includes READ, READ/CLEAR, READ/SET, and READ/WRITE.

### BRIEF DESCRIPTION OF THE DRAWINGS

FIG. 1 illustrates a multi-processor system of the prior art.

FIG. 2 illustrates a multi-processor system of the prior art.

FIG. 3 illustrates an illustrative example of the configuration register of the present invention.

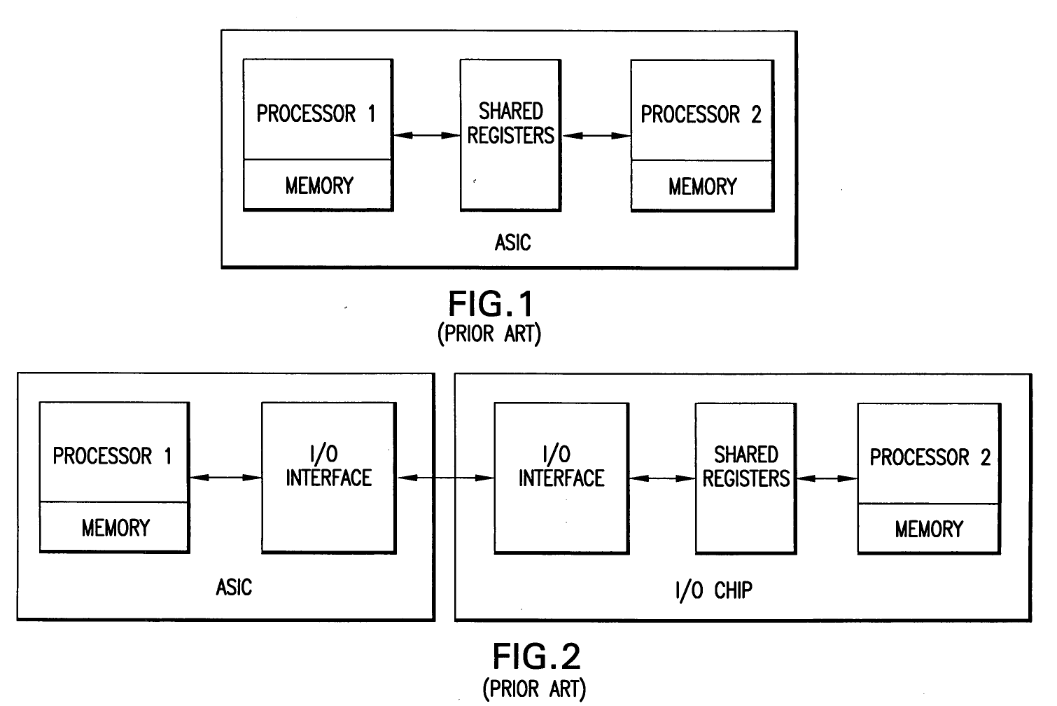

### DETAILED DESCRIPTION

The present invention is a contention management protocol that is hardware configurable at run-time for flexibility and robustness. For each element, e.g. bit, register, or bank of registers, the programmable contention management specifies what level of write access each processor has to the specified element.

The access types are defined: READ, READ/CLEAR, READ/SET, and READ/WRITE. For READ, the processor may only read the element. Attempts to write are ignored or optionally generate an error. For READ/CLEAR, the processor may read or clear bits within the element. For READ/SET, the processor may read or set bits within the element. For READ/WRITE, the processor may read, set, or clear bits within the element.

The access types permit simple handshaking protocols to be implemented between processors. For example, a simple interlocked handshake is implemented when one processor is only allowed to set a particular element and a second processor is only allowed to clear it.

In addition to the access type, an optional arbitration priority is also specified. This defines what happens when there is a conflict between processor access types. To illustrate, if one processor tries to READ/CLEAR a particular element while another processor tries to READ/SET the same element, the arbitration priority defines the outcome. For systems implemented without arbitration priority, the access types would be configured as mutually exclusive.

In one illustrative embodiment for a two-processor system, 5 configuration bits may be used for each element as shown in Table 1.

TABLE 1

| | |
|---|---|
| accessTypeCpu1 | READ = 00, READ/CLEAR = 01, |
| | READ/SET = 10, READ/WRITE = 11 |
| accessTypeCpu2 | READ = 00, READ/CLEAR = 01, |
| | READ/SET = 10, READ/WRITE = 11 |
| ArbitrationPriority | Processor1 = 0, Processor2 = 1 |
| Configuration[4:0] | {ArbitrationPriority, AccessTypeCpu1, |
| | AccessTypeCpu2) |

Hence, a value of “10110” would indicate that processor1 has READ/CLEAR access and Processor2 has READ/SET access. In the event of a conflict, Processor2 has priority of Processor1. This might be used for an interrupt from Processor2 to processor1. Processor2 sets the interrupt bit and it remains set until Processsor1 acknowledges clearing it.

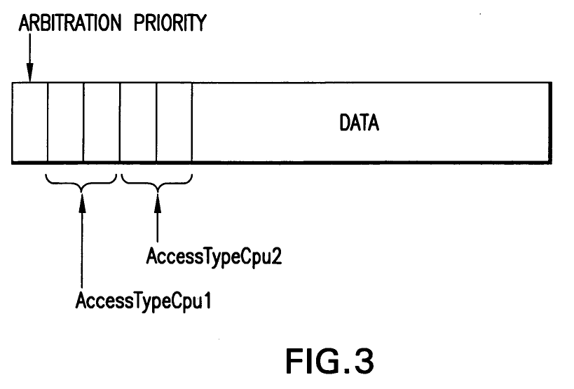

FIG. 3 illustrates an illustrative example of the data within a shared system or configuration register. In this embodiment, the most significant five bits are used for access control. The remaining bits in the register store the data.

The invention allows configuration of a wide range of interface protocols to permit hardware to be developed before a protocol is known and to allow hardware to be reconfigured to support a different protocol. The most generic implementation would provide the configuration bits for each bit in a register. However, a lower cost implementation is possible by protecting collections of bits or registers. The configuration bits can be controlled by a single processor or jointly. Alternatively, the access protocol may be encoded and selected as a build-time option in the hardware design source code or encoded and provided as input signals to the hardware design.

One with skill in the art may extend the inventive concept. For an multi processor system having N processors, where N is an integer, N≧2, each programmable configuration register consists of 2 N bits, where each of the configurable access types are encoded into 2 bits. When the optional arbitration priority is included, an additional N*ceiling(log₂ N) bits may be used, each set of ceiling(log₂ N) bits provides for relative arbitration priority of each processor. The ceiling function is defined as follows: for any given real number x, ceiling(x) is the smallest integer no less than x. For example, in a 8-processor system, the relative priority of each processor could be encoded in 3 bits. If each processor is encoded with a unique arbitration priority number, the logic can determine which processor has write priority. In this example case, 5 bits would be required per processor, or a total of 40 bits for each shared register element.

1. A system comprising:
shared system registers, each register including an access protocol and data; and
N processors, n≧2, where n is an integer, each accessing the registers:

2. A system, as defined in claim 1, the access protocol including a configurable access type for each N processors.

3. A system, as defined in claim 2, the access type being selected from a group that includes READ, READ/CLEAR, READ/SET, and READ/WRITE.

4. A system as defined in claim 3, comprising programmable configuration registers operative to encode and store the access protocol, each configuration register corresponding to one of the shared system registers.

5. A system, as defined in claim 4, wherein:
each programmable configuration register consisting of N*2 bits; and
the configurable access types are encoded into 2 bits.

6. A system as defined in claim 3, the access protocol encoded and provided as input signals to the hardware design.

7. A system, as defined in claim 3, the access protocol encoded and selected as a build-time option in the hardware design source code.

8. A system, as defined in claim 3, the access protocol further including an arbitration priority.

9. A system as defined in claim 8, comprising programmable configuration registers operative to encode and store the access protocol, each configuration register corresponding to one of the shared system registers.

10. A system, as defined in claim 9, wherein:
N is 2; and
each programmable register including 5-bits, 2 bits represent the access type of one of the two processors, 2 bits represent the access type of the other of the two processors, and 1 bit represents the arbitration priority.

11. A system, as defined in claim 9, wherein:
each programmable configuration registers consists of N*(2+ceiling(log₂ N)) bits; and
the access protocol including the four access types are encoded into 2 bits per processor and the arbitration priority encoded into ceiling(log₂ N) bits.

12. A system, as defined in claim 8, the access protocol encoded and selected as a build-time option in the hardware design source code.

13. A system as defined in claim 8, the access protocol encoded and provided as input signals to the hardware design.
